(19) United States
(12) Patent Application Publication
(10) Pub. No.: US 2018/0223974 A1
(43) Pub. Date: Aug. 9, 2018

(54) FOUR-SPEED MOTORCYCLE TRANSMISSION

(71) Applicant: Piaggio & C. S.p.A, Pontedera (PI) (IT)

(72) Inventors: Paolo NESTI, Pontedera (PI) (IT); Walter MARIOTTI, Pontedera (PI) (IT)

(73) Assignee: Piaggio & C. S.p.A, Pontedera (PI) (IT)

(21) Appl. No.: 15/749,458

(22) PCT Filed: Aug. 1, 2016
(86) PCT No.: PCT/EP2016/068326

§ 371 Date: Jan. 31, 2018

(30) Foreign Application Priority Data
Aug. 3, 2015 (IT) 102015000041477

(51) Int. Cl. F16H 37/04; F16H 3/089; F16H 3/10; F16H 9/24; B62M 9/04; B62M 11/06

(52) U.S. Cl. CPC F16H 37/043; F16H 3/089; F16H 3/10; F16H 2200/0043; B62M 9/04; B62M 11/06; F16H 9/24

(57) ABSTRACT

A four-speed transmission (1) for motorcycles has performances similar to those of a continuously variable transmission but, at the same time, a high yield and an easy and automatic operation and it comprises: a crankshaft (2) with a first and a second pulley (9, 10) mounted thereon; a primary shaft (3), with third and fourth pulley (10, 14) and a first and a second gear (18, 19) mounted thereon; transmission belts (11, 13) connecting said pulleys for the transmission of the first and the second speed and of the third and the fourth speed respectively; a secondary shaft (4) with a third and a fourth gear (20, 21) engaged with said first and second gear (18, 19) for transmitting the first and the third speed, and the second and the fourth speed respectively; a first synchronizer (16), which activates the transmission of the third and the fourth speed; and a second actuated synchronizer (17), actuating the transmission of the second and the fourth speed; wherein a first and a second free wheel (15, 22) can release the transmission of the third and the fourth speed and of the first and third speed respectively.

The present invention has as subject a four-speed synchronous transmission, in particular to be used aboard a motorcycle, such as a scooter, as transmission means for transmitting the motion generated by an engine to a single driving wheel or a double driving wheel, in particular the rear wheel of a motorcycle. In the following, motorcycles and scooters are considered equivalent.

In the last generation scooters the most commonly used transmission is of the CVT (Continuously variable transmission) type, called continuous transmission or continuous variator.

CVT has the advantage of providing a continuous traction and of not requesting the manual actuation of the different ratios. However, by using means of sliding type, such transmission is characterized by a low efficiency, above all in the transitory manoeuvers when the hysteresis effect of the transmission belt is maximum.

This pushes downwards the general efficiency of the vehicle and increases the consumption thereof.

On the other hand, a much felt requirement in the field is that of limiting the consumption as much as possible, however, if requested by the market, by keeping the comfort level thereto the users have got used by the CVT transmission.

U.S. Pat. No. 4,505,352 A discloses a transmission for motorcycles having pulleys but no free wheel to transmit the motion.

European Patent Application No. 2,151,602 A1 discloses a stepped automatic transmission for motorcycles having hydraulic clutches and no pulley; and Chinese Utility Model No. CN 201 784 785 U discloses a gearbox for an electric motorcycle.

The object underlying the present invention is then to significantly increase the overall efficiency of the transmission in two-wheel or three-wheels motorcycles for urban transport.

The idea underlying the invention is to provide a synchronous transmission, i.e. including synchronous or nearly synchronous belts, e.g. belts equipped with suitable teeth for the synchronous transmission of the motion from pulley to belt and from belt to pulley, wherein the hysteresis effect is reduced to the minimum and therefor the transmission efficiency can be compared to the one which can be obtained with systems of pinion-chain-crown type.

In order to guarantee an adequate range, i.e. the value given by the ratio in the highest gear divided by the ratio in the first gear, and which can be compared to the one guaranteed by a traditional CVT system, it is possible providing the use of four gears.

Therefore, the above-mentioned problem is solved by a four-speed motorcycle synchronous transmission as specified above, comprising:
a crankshaft, which receives the motion by an engine, having a first and a second pulley mounted thereon;
a primary shaft, having a third and a fourth pulley and a first and a second gear mounted thereon,
a first transmission belt connecting said first and said third pulley, for the transmission of the first and the second speed;
a second transmission belt connecting said second and said fourth pulley, for the transmission of the third and the fourth speed;
a secondary shaft connected to a driving wheel, comprising a third and a fourth gear, respectively engaged with said first and second gear of the primary shaft;

the first and the third gear being apt to transmit the first and third speed, and the second and fourth gear being apt to transmit the second and the fourth speed,
a first synchronizer, which activates the transmission of the third and the fourth speed; and
a second actuated synchronizer, which activates the transmission of the second and the fourth speed,

a first free wheel being provided on the transmission of the third and the fourth speed and a second free wheel being provided on the transmission of the first and the third speed, on the respective pulleys and gears.

The main advantage of the four-speed synchronous transmission according to the present invention lies in obtaining performances similar to those of a continuously variable transmission but, at the same time, a high yield and an easy automatic operation.

In the light of the above, it is possible implementing this four-speed transmission in a simple and compact solution which can be automatized.

The present invention will be described hereinafter according to some preferred embodiment examples thereof, provided by way of example and not with limitative purposes by referring to the enclosed drawings wherein:

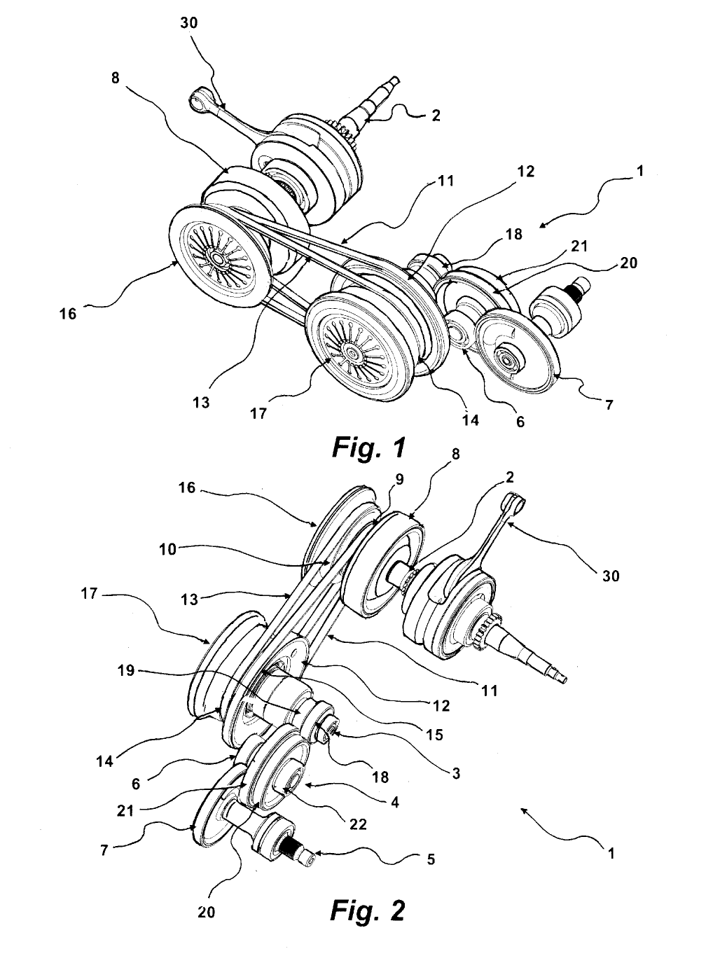

FIG. 1 shows an axonometric view of a first example of four-speed synchronous transmission according to the invention;

FIG. 2 shows an axonometric view of the synchronous transmission of FIG. 1, taken from a different angulation;

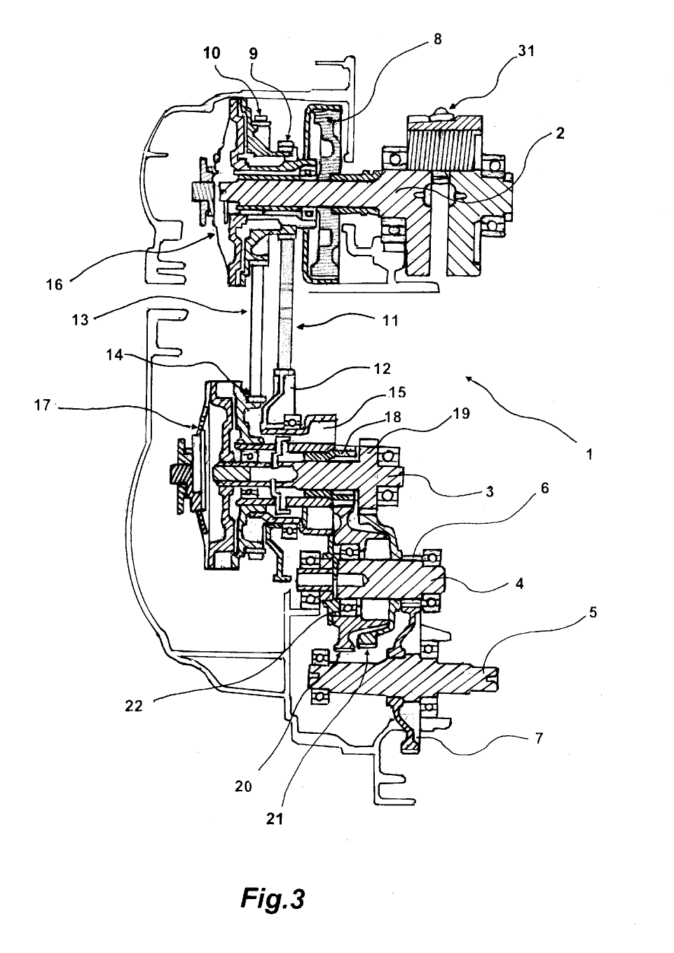

FIG. 3 shows a longitudinal section view of the synchronous transmission of FIG. 1;

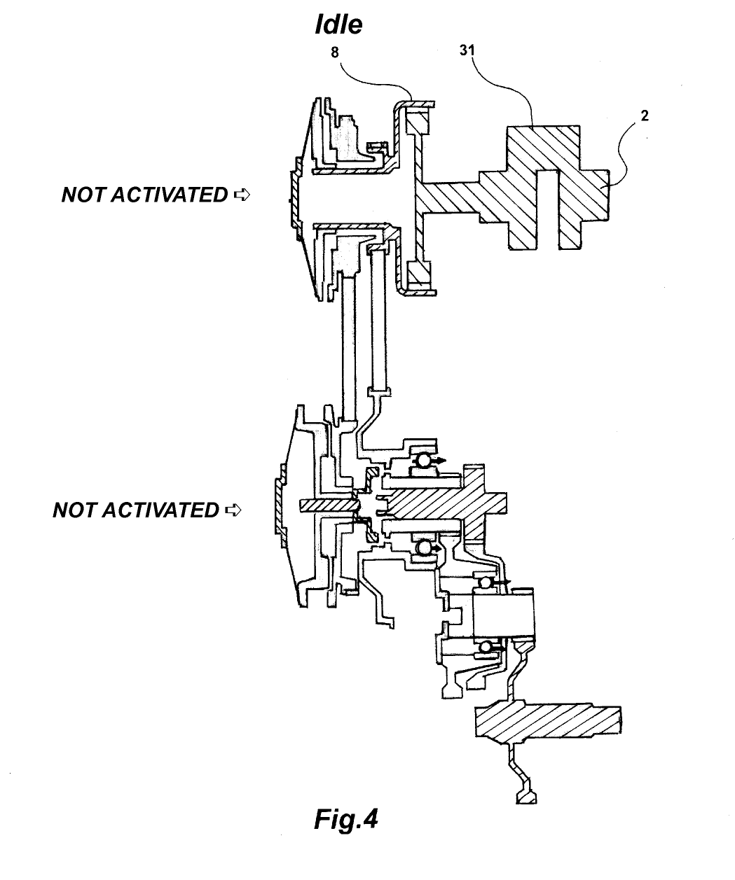

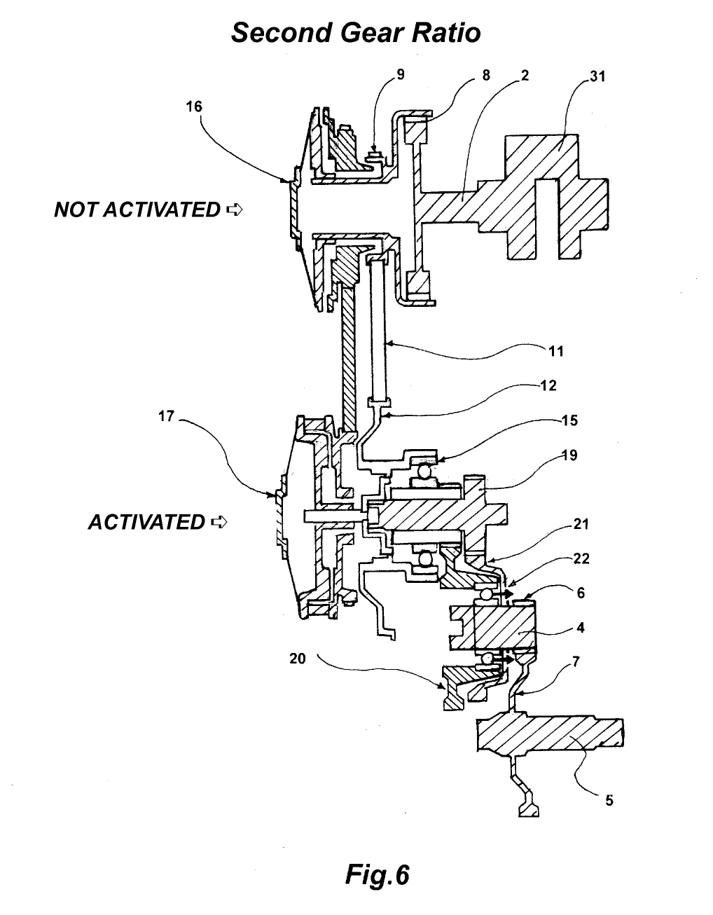

FIGS. 4 to 8 show schematized longitudinal section views of the synchronous transmission of FIG. 1, illustrating the operation of the different transmission ratios; and

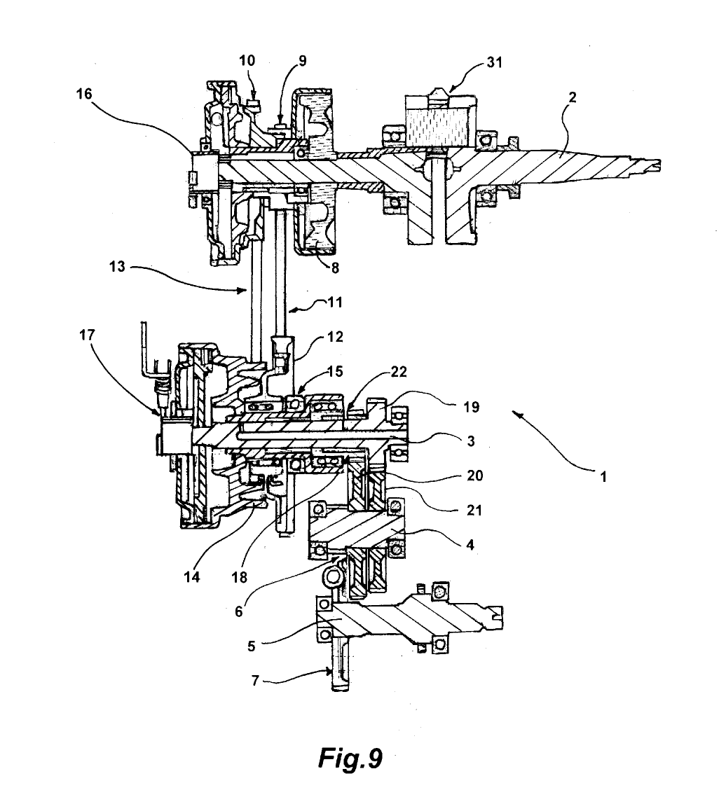

FIG. 9 shows a longitudinal section view of a second example of four-speed synchronous transmission according to the invention.

By referring to FIGS. 1 to 3, a speed transmission with several gears, in particular four speeds, is designated as a whole with 1. It is of the type suitable to be assembled on a motor vehicle as transmission means which actuates a driving wheel of the motor vehicle, in particular a scooter, that is the (not represented) rear wheel thereof.

To this purpose, it comprises a crankshaft 2, which is made to rotate by the engine, thereof the relative piston rod 30 (FIGS. 1 and 2) and crank 31 (FIGS. 3 to 9) are represented, and a first driven shaft, that is the primary shaft 3, and a secondary shaft 4, which can be connected directly to the wheel or which transmits the rotation, as in the present embodiment example, to a hub shaft 5 which is connected to the driving wheel of the vehicle.

It is to be noted that the arrangement of the shafts is so that the crankshaft 2 assumes a position which is substantially parallel to the rotation axis of the driving wheel, that is the hub shaft 5. Therefore, this transmission organ has the task of transferring the motion from an engine, which has a crankshaft transversal to the motor vehicle, to a wheel having, too, an axis transversal to the vehicle.

The passage from secondary shaft 4 to a hub shaft 5 takes place through a pair of gears 6, 7 having the function of inverting the rotation direction transmitted to the driving wheel, which in this case is simultaneous to the rotation direction of the crankshaft 2, and they insert a fixed reduction ratio onto the hub.

It is to be meant that the hub shaft 5 could be constituted by the same secondary shaft 4, provided that one goes without the above-mentioned reduction ratio on the hub and one provides to invert the rotation direction of the crankshaft 2.

In the light of what illustrated above, in any case the secondary shaft is directly or indirectly connected, from the mechanical point of view, to the driving wheel thereto the transmission refers.

The crankshaft 2 and the primary shaft 3 are substantially parallel and they are connected by transmission means allowing to transmit the motion according to different speed ratios. Such transmission means comprises a first group of toothed pulleys assembled on the crankshaft 2, a second group of toothed pulleys assembled at the primary shaft 3, and a pair of transmission belts extending from the first to the second group of pulleys.

Under transmission belt any flexible annular means is meant apt to transmit the motion between two pulleys offset therebetween, in particular with axes parallel therebetween. The transmission belts then comprise any kind of belts or chains, the pulleys being able to be in case even toothed to implement a synchronous connection.

In the present embodiment example as well as in the subsequent ones, the transmission belts advantageously are synchronous transmission belts; under synchronous belt a belt is meant, usually a toothed belt or a roller chain, transmitting the motion from a wheel or toothed pulley to another wheel or toothed pulley with a transmission ratio which is determined by the ratio between the diameters of the wheels, without it suffers from losses by friction or sliding.

The absence of sliding portions and/or portions dragged by friction, typical instead of the transmissions of CVT (Continuously variable transmission) type, also known as continuous transmissions or continuous variators, makes the herein described speed transmission of synchronous type.

Therefore, in the present embodiment example as well as in the subsequent ones, the above-mentioned pulleys are toothed pulleys, connected by toothed belts, preferably of the type made of rubber.

On the crankshaft 2 a main clutch 8 is assembled which, in the present example, is of centrifugal type, well known in the art. This clutch type allows transmitting the motion from the crankshaft 2 to the transmission means, and automatically a rotation regime comprised in a prefixed range, for example between 1000 and 2000 revolutions per minute, is established. At a lower rotation regime, the clutch 8 is not engaged and the engine is in neutral, whereas the driving wheel is not stressed.

It is meant, however, that in particular applications, this clutch type can be replaced by a clutch with manual coupling which is perfectly equivalent, or by a clutch actuated by a servomechanism.

In any case, the transmission 1 comprises a driven tract of crankshaft 2 receiving the motion through said main clutch 8, from a driving tract of the crankshaft receiving the motion from the piston.

After said clutch 8, on the crankshaft 2 a first pulley 9 and a second pulley 10 are mounted. They are respectively connected, by means of a first synchronous belt 11, to a third pulley 12 and, by means of a second synchronous belt 13, to a fourth pulley 14.

The third pulley 12, in the present example, is assembled on a first free wheel 15, mounted on the primary shaft 3.

Furthermore, on the top of the crankshaft 2, there is a first synchronizer 16 for the synchronization of the second belt 13, that is the connection between the second and the fourth pulley 10, 14, whereas on the top of the primary shaft 3 there is a second synchronizer 17 synchronizing the gears mounted on such primary shaft 3, as it will be explained in details hereinafter.

On the primary shaft 3 a first and a second gear, designated with 18 and 19 are mounted, which are respectively in engagement with a third gear 20 and with a fourth gear 21, both mounted on the secondary shaft 4. The third gear 20, in this embodiment example, is assembled on a second free wheel 22.

The operation of the above-described transmission is so schematically summarized: at first, the engine runs idle (FIG. 4) and it results to be detached from the transmission thanks to the presence of the main clutch 8 of centrifugal type which, at the minimum revolutions, results to be open.

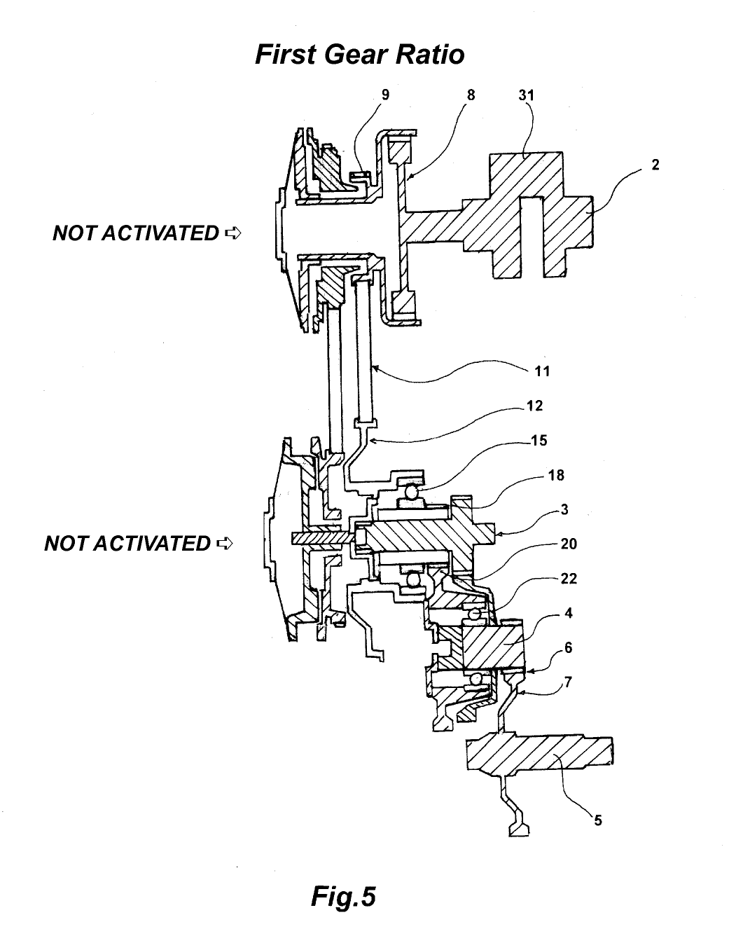

At a predetermined rpm's (FIG. 5), the centrifugal clutch 8 closes and, through the first pulley 9 related to the first and the second speed, the motion from the crankshaft 2 is transmitted to the primary shaft 3 of the transmission 1 which is dragged by the third pulley 12; the transmission of the motion takes place through the first synchronous belt 11. From the primary shaft 3, the rotation is transmitted to the secondary shaft 4 through the first and the third gear 18, 20, and from the secondary shaft 4 the motion is transmitted to the hub shaft 5 through the pair of gears 6, 7.

At a predetermined moment, which can be decided by the driver or can be set autonomously by the system, according to a well precise implemented logic, the system is requested to pass from the first to the second speed and, even in this case, the transmission uses the first synchronous belt 11 (FIG. 5).

In this case, however, the second actuated synchronizer 17 arranged on the primary shaft 3 is activated and then it intervenes by synchronizing the pair of gears, the second and fourth gear 19, 21, apt to the transmission of the second and the fourth speed.

To this regard, since the secondary shaft 4 starts rotating faster than the speed thereat it could rotated if it drove the transmission ratio assigned to the first speed, the first and the third gear 18, 20 is exceeded and then excluded thanks to the presence of the second free wheel 22 arranged on one of said wheels, in particular the third gear 20.

At this point, since the primary shaft 3 of the transmission 1 starts rotating faster than the speed thereat it could rotate if it drove the transmission ratio assigned to the first one, the pair formed by the first and the third pulley 9, 12 is exceeded and then excluded. The primary shaft 3 then rotates with the ratio set by the second gear (FIG. 4).

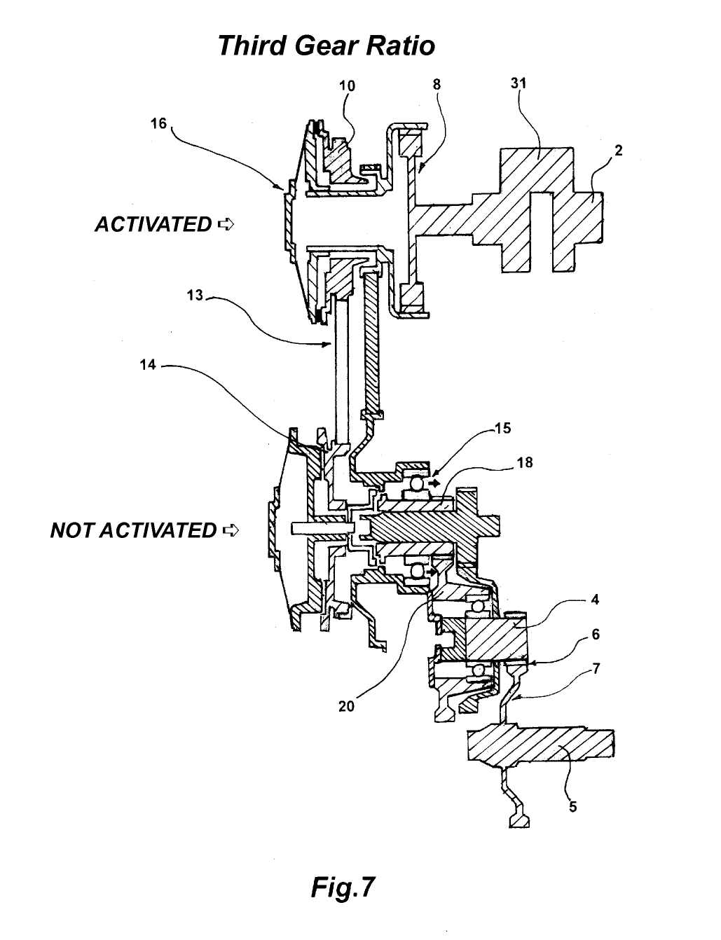

At a predetermined moment, which can be decided by the driver or it can be set autonomously by the system, according to a well precise implemented logic, the system is requested to pass from the second to the third speed and, in this case, the transmission has to use the second synchronous belt 13 (FIG. 7).

The first synchronizer 16 placed onto the driving axle 2 is activated, by implementing the synchronization of the second pulley 10 of the third and fourth gear. In the latter case, the second synchronous belt 13, now placed in motion, transmits the motion to the primary shaft 3 of the transmission. As the two belts 11, 13 are in motion contemporarily, the first shaft 3 would have two different speeds set by the transmission, however this is avoided by the presence of a first free wheel 15 allowing to release the third pulley 13 related to the first and second gear.

However, in the same moment, on the driven axis, the second synchronizer 17 on the primary shaft 3 has to be deactivated, so as to cease the synchronization of the ratio of gears of second and four gear. Therefore, the motion reaches the primary shaft 3 through the pair of pulleys related to the third and fourth speed, and the primary shaft 3 rotates with the speed set by the third gear.

Likewise, the motion passes from the primary shaft 3 to the secondary shaft 4 through the first and the third gear 18, 20, apt to the transmission of the first and the third speed.

In the present case, it is to be noted that the synchronizer has to be deactivated regardless the rotation speed reached by the respective primary shaft 3, and this makes that it has to be of actuated type, that is of the type which is activated or de-activated after an actuation determined by a system decision and not by the simple reaching of a rotation regime.

On the other hand, it is to be noted that the first synchronizer 16, acting on the crankshaft 2 to synchronize the transmission of the third and the fourth speed, can be of not actuated type, that is of the type which activates upon reaching a predetermined rotation regime, as it happens in a synchronizer of centrifugal type well known in the art.

However, in the herein illustrated embodiment examples, both synchronizers 16, 17 are of the actuated type, in order to obtain the freedom of being able to impose on the system any transmission ratio by a system with a control logic or in case by the driver.

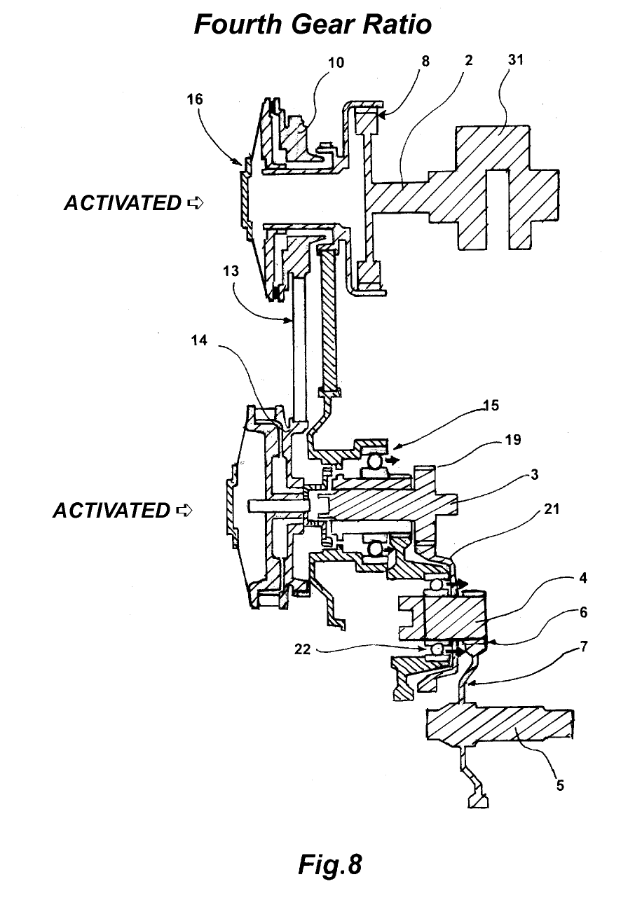

As last case the insertion of the fourth speed remains (FIG. 8). As to the first synchronizer 16 on the crankshaft nothing changes with respect to the case of the third speed. In fact, the second belt 13 between the second and the fourth pulley 10, 14 continues to be active.

However, for the fourth gear, even the second synchronizer 17 has to intervene which is actuated on the primary shaft 3, by synchronizing again the pair or gears, the second and the fourth ones 19, 21, contributing to the second and fourth speed.

Again, the presence of the second free wheel 22 on the secondary shaft 4 prevents that two transmission ratios are present at the same time on the same shaft. In particular, the pair of gears 18, 20 related to the transmission of the first and the third speed are released and they do not transmit motion due to the higher speed set by the pair of second and fourth gear 19, 21. In this way, the secondary shaft 4 rotates with a speed set by the fourth speed.

The activation scheme of the two synchronizers can be so summarized in the following table I:

TABLE I

| | First | Second |
|---|---|---|
| | synchronizer | synchronizer |
| I speed | 0 | 0 |
| II speed | 0 | 1 |
| III speed | 1 | 0 |
| IV speed | 1 | 1 |

disabled = 0
active = 1

In the description of the first embodiment example a particular arrangement of the free wheels 15, 22 was considered.

In the specific case, a first free wheel was inserted on the primary shaft 3 of the transmission, necessary to release the transmission related to the first and second speed, and a second free wheel 22 on inserted on the secondary shaft 4, necessary to release the transmission of the first and the third speed.

The same functionality of transmission system can be obtained in the second embodiment (FIG. 9), wherein even the second one 22 of the free wheels is assembled on the primary shaft 3 of the transmission, still with the purpose of releasing the transmission of the first and the third speed.

To this regard, the second free wheel 22 is assembled on the first gear 18.

Such option, if on one side makes the supporting configuration of the primary shaft 3 a little more complicated, on the other side it makes the definition of the gears 18, 20 related to the first and the third speed definitely simpler.

In addition in this latter case, it is necessary, due to reasons of overall dimensions and suitable supporting scheme, to move even the first one 15 of the two free wheels. The latter then is substantially aligned to the third pulley 12 related to the first and second gear.

This aspect, from a functional point of view, is very positive as the tension of the first belt 11 practically does not produce any inflection of the primary shaft 3 any more, by making the free wheel itself to work in a better way.

It is to be noted that, by considering the aim of the first free wheel 15, which is that of releasing, upon required, the transmission of the first or of the second speed, it could be arranged even on the crankshaft 2, to support the first pulley 9.

At last, the selection of the arrangement of the free wheels is not univocal. In particular, the free wheel apt to release the engagement of the first and the third speed could be implemented both on the primary shaft and on the secondary one without modifying in any way the philosophy underlying the present transmission.

To the above-described four-speed synchronous transmissions a person skilled in the art, with the purpose of satisfying additional and contingent needs, could bring several additional modifications, however all within the protection scope of the present invention, as defined by the enclosed claims.

1. A motorcycle four-speed transmission (1), to be used aboard a motorcycle as transmission means for transmitting motion generated by an engine to a driving wheel of the motorcycle, the four-speed transmission comprising:
a crankshaft (2), which receives the motion by the engine, having a first and a second pulley (9, 10) mounted thereon;
a primary shaft (3), having a third and a fourth pulley (10, 14) and a first and a second gear (18, 19) mounted thereon,
a first transmission belt (11) connecting said first and said third pulley (9, 12), for the transmission of the first and the second speeds;
a second transmission belt (13) connecting said second and said fourth pulley (10, 14), for the transmission of the third and the fourth speeds;
a secondary shaft (4) connected to a driving wheel, having a third and a fourth gear (20, 21) mounted thereon, respectively engaged with said first and second gear (18, 19) of the primary shaft (3);
the first and the third gears (18, 20) configured to transmit the first and third speeds, and the second and fourth gears (19, 21) configured to transmit the second and fourth speeds,
a first synchronizer (16), which activates the transmission of the third and the fourth speeds; and
a second actuated synchronizer (17), actuating the transmission of the second and the fourth speeds,
a first free wheel (15) being provided on the transmission of the third and the fourth speeds and a second free wheel (22) being provided on the transmission of the first and the third speeds, on the respective pulleys and gears.

2. The four-speed transmission (1) according to claim 1, wherein the first synchronizer (16) is actuated.

3. The four-speed transmission (1) according to claim 1, wherein the first synchronizer (16) is assembled at the crankshaft (2).

4. The four-speed transmission (1) according to claim 1, wherein the second synchronizer (17) is assembled at of the primary shaft (3).

5. The four-speed transmission (1) according to claim 1, wherein the first free wheel (15) is assembled on the primary shaft (3), at said third pulley (12).

6. The four-speed transmission (1) according to claim 1, wherein the second free wheel (22) is assembled at the secondary shaft (4), at said third gear (20).

7. The four-speed transmission (1) according to claim 1, wherein the second free wheel (22) is assembled at the primary shaft (3), at said first gear (18).

8. The four-speed transmission (1) according to claim 1, wherein the first and second transmission belts (11, 13) are synchronous belts, said pulleys (9, 10, 12, 14) being toothed for implementing a synchronous transmission of the motion.

9. The four-speed transmission (1) according to claim 1, wherein the crankshaft (2) comprises a centrifugal clutch (8).

10. The four-speed transmission (1) according to claim 1, wherein the secondary shaft (4) is engaged with a hub shaft (5), which is connected directly to the driving wheel, by means of a pair of gears (6, 7) determining a reducing ratio.

11. Motorcycle or scooter vehicle including a four speed transmission of claim 1.
